(19) United States
(12) Patent Application Publication
(10) Pub. No.: US 2012/0203705 A1
(43) Pub. Date: Aug. 9, 2012

(54) System And Method For Universal In-Place Lifecycle Policy Enforcement On Repositories

(76) Inventors: Pierre Van Beneden, Avully (CH); Bassam Zarkout, Ottawa (CA); Serge Quiniou, Douvaine (FR); Hughes Cazeaux, Beaumont (FR)

(21) Appl. No.: 13/369,289

(22) Filed: Feb. 8, 2012

Related U.S. Application Data
(60) Provisional application No. 61/440,705, filed on Feb. 8, 2011.

(51) Int. Cl. G06Q 10/00

(52) U.S. Cl. 705/317

(57) ABSTRACT

A system and method for identifying eligible and approved governance lifecycle actions on information assets, and for enforcing (and carrying out) these actions (in a universal way) on information assets while they remain in-place in their repositories. The system and method includes three integrated modules. First, an Information Governance Policy Module (IGPM) for creating a Master Classification (MC) of Record Classes (RC) for the entity and corresponding governance rules for each. Second, an Information Governance Control Module (IGCM) allowing administrators in the sub-entities to create and manage file plans using the RC definitions in IGPM, associate these file plans with jurisdictions, and manage sub-entity's records within them. Third, a Governance Policy Enforcement Layer (GPEL) comprising one or multiple software connectors. These are software modules that tie (connect) IGCM to various repositories of information assets, and enforce the eligible and approved governance lifecycle actions on the in-formation assets located in the repositories.

### CROSS-REFERENCE TO RELATED APPLICATION

This application claims the benefit of priority to U.S. provisional patent application Ser. No. 61/440,705, filed on Feb. 7, 2011.

### FIELD OF THE INVENTION

The present invention relates to an Information Governance technology platform that manages and enforces the lifecycle of information and records. The invention may be particularly suited for managing and enforcing the lifecycle of information and records in accordance with the requirements that may be (i) mandated by laws and regulations in different jurisdictions, (ii) defined by industry best practices, (iii) defined by internal business requirements, and/or (iv) defined by the internal policies of an entity.

### BACKGROUND OF THE INVENTION

The prior art lacks an efficient way for an entity to create a unified Master Classification covering Record Class definitions with composite and multi-jurisdictional governance policies and rules, manage the lifecycle of the information assets of an entity in accordance with these policies and rules, and finally enforce eligible lifecycle actions on the information assets while they remain in their repositories. The Master Classification is a list of Record Classes which comprise unique record types (e.g., invoice, statement, purchase order, etc.) organized in a hierarchy, often a functional hierarchy. The Record Classes and their governance policies reflect multi-jurisdictional requirements. These jurisdiction-aware policy definitions are directly available within the file plans in the sub-entities of an entity for use to manage the lifecycle of their records. Finally, the lifecycle actions may include destruction, migration, transfer, and any other action that may be performed on an information asset as a result of a governance policy that determines its lifecycle attributes.

An entity seeking to manage its records in such complex environments must rely on highly manual and lengthy processes. These are the collaborative processes to create and manage file plans in multiple jurisdictions, manage the lifecycle of records within these file plans, and enforce the lifecycle actions on the information while they remain in their repositories. These collaborative processes are highly manual and lengthy because they involve parties within the entity that are geographically and functionally dispersed, and are conducted in meetings, email exchanges, and spreadsheets. As the number of jurisdictions and the size of the entity increase, the limitations of the current art grow significantly and these manual processes become unmanageable.

In large and global entities, this process and these activities involve disparate teams both at the corporate level as well as at business operational levels across multiple jurisdictions. The diverse rules in various jurisdictions and the multitude of repositories makes it extremely difficult to govern information within global entities in a reliable and sustainable manner.

### SUMMARY OF THE INVENTION

The invention may be embodied as an integrated computer-based system for managing records having one or more microprocessors, a record repository, and a communications network. In one embodiment, the microprocessors are programmed to execute instructions of a policy module. The policy module is configured to receive a plurality of management inputs and produce a governance policy for a record class using the management inputs. The governance policy may include a description of the management inputs and/or identify jurisdictions for which the policy is applicable. The governance policy may also identify a business event that triggers application of the governance policy. In one embodiment, at least one of the governance policies identifies a duration after which the policy is applied. The policies may also identify at least one action that is triggered after the occurrence of an event and the passing of a time period. Each governance policy may include more than one requirement. At least one of the requirements may have an application date that is different from the other requirements. In another embodiment, each governance policy is associated with a class of records.

Each management input describes a requirement that may arise from legal, business, and/or information technology considerations. In one embodiment, the legal considerations arise from more than one jurisdiction. The requirement describes how a governance function must be carried out with respect to a record class.

The microprocessors are also programmed to execute instructions of a control module. The control module is configured to receive a selection of one or more of the governance policies produced by the policy module and apply the selected governance polices to records created by a business division. In one embodiment, more than one governance policy is selected for a particular one of the records, and the selected governance policies are applied independently of each other to the particular one of the records.

The microprocessors may also be programmed to execute instructions of a connector module to apply governance actions. The actions are determined by the control module, and apply to records within one or more record repositories. In one embodiments, the connector module may be responsive to a command from the control module to discover and identify records located within a repository. In another embodiment, the connector module may be responsive to a command from the record repository to catalog a record within a folder located within a file plan and associated with a record class. The record may be already stored in the record repository. The cataloging action comprises creating a record entry in the control module's file plan, creating metadata entries for that record in the control module file plan, and turning immutability on for that record in the record repository. The created record entry in the control module's file plan may be placed in a selected folder representing the record.

In another embodiment, the connector module may be responsive to instructions from the control module to store an electronic copy of the record located within the record repository into a record repository of the control module. The connector module may also be responsive to instructions from the control module to search for a record located within a record repository. In one embodiment, the connector module is responsive to instructions from the control module to access, retrieve, and display a record located within a record repository.

The application of the governance actions may include deleting a record, deleting metadata associated with a record, deleting full-text indexes belonging to a record, placing a litigation hold on the record, releasing the litigation hold from the record, moving a record from one record repository to another location, or reducing the security classification of a record to a lower security classification. In another embodiment, the another location is a record repository.

The record repository stores the records created by the business division. The repository is responsive to the control module's application of the selected governance policies by storing, imposing immutability on, imposing mutability on, or deleting records according to the selected policies.

The communications network connects the microprocessors and the record repository to facilitate receipt of management inputs, and the selection and application of governance policies.

In one embodiment of the invention, icons may appear in a file plan. The icons correspond to records of a business unit. The file plan is a graphical representation of a hierarchical organization of icons corresponding to record classes, folders, sub-folders, and records. Each file plan may be associated with a jurisdiction and a set of governance policies representing the governance policies applicable in that jurisdiction. Some icons may represent one or more of the record classes as defined in the policy module. Each record class may correspond to a unique type of record, such that each type of record identifies a particular business function. Some icons corresponding to folders and sub-folders represent organizational units of records having common features.

The invention may also be embodied as a computer-based method for managing records. The method comprises providing one or more microprocessors, a record repository, and a communications network. The method also comprises receiving management inputs producing a governance policy, receiving a selection of one or more of the governance policies, and using a connector module to apply the governance policies to the records.

In one embodiment, the microprocessors are programmed to execute instructions of a policy module. The policy module is configured to receive a plurality of management inputs and to use the management inputs to produce a governance policy for a record class. Each management input may describe a requirement arising from legal, business, and/or information technology considerations. The requirement may describe how a governance function must be carried out with respect to the record class.

The microprocessors are also programmed to execute instructions of a control module. The control module is configured to receive a selection of one or more of the governance polices produced by the policy module and apply the selected governance policies to records created by a business division.

The microprocessors may also be programmed to execute instructions of a connector module to apply governance actions, determined by the control module, on records within one or more record repositories. In one embodiment, the connector module may be responsive to a command from the control module to discover and identify records located within a repository. Upon receiving the command, the connector module may initiate actions to discover and identify records located within the repository.

In another embodiment, the connector module is responsive to a command from the record repository to catalog a record. The record may already be stored in the record repository. The command from the record repository may be to catalog a record within a folder located within a file plan and associated with a record class. The response of the connector module to the command may be to execute a catalog action. Catalog actions may include creating a record entry in the control module's file plan, creating metadata entries for that record in the control module file plan, and/or turning immutability on for that record in the record repository. The record entry may be created in a selected folder representing the record.

In one embodiment, the connector module is configured to respond to instructions from the control module to apply governance actions to the record located in the record repository. The connector module may receive instructions from the connector module and respond by applying a number of governance actions. The governance actions may include deleting a record, deleting metadata associated with a record, deleting full-text indexes belonging to a record, placing a litigation hold on the record, releasing the litigation hold from the record, moving a record from one record repository to another location, or reducing the security classification of a record to a lower security classification. In another embodiment, the governance actions are applied independently of each other.

In another embodiment, the connector module is responsive to instructions from the control module to store an electronic copy of the record located within the record repository into a record repository of the control module. The method may further include receiving the instructions, and using the connector module to store the electronic copy of the record into the record repository of the control module.

In one embodiment, the connector module is responsive to instructions from the control module to search, access, retrieve, and/or display a record located within a record repository. The method may further comprise receiving the instructions and using the connector module to search, access, retrieve, and/or display a record located within the record repository.

The record repository may store records of the business division. The repository may also be responsive to the connector module's application of the selected governance policies by storing, imposing immutability on, imposing mutability on, or deleting the records according to the selected governance policies.

The communications network connects the microprocessors and the record repository. The network may facilitate the receipt of the management inputs, and the selection and application of the governance policies.

In one embodiment, producing the governance policy may include adding a description of the management inputs and/or includes identifying jurisdictions for which the governance policy is applicable. Producing the governance policy may also include identifying a business event that triggers application of the governance policy.

In another embodiment, at least one of the governance policies may identify a duration after which the governance policy is applied. The step of applying the at least one governance policy may occur once the duration is achieved.

In one embodiment, at least one of the governance policies may identify at least one action that is triggered after the occurrence of an event and the passing of a time period. The step of applying the at least one governance policy occurs once both the event occurs and the time has passed.

In another embodiment, the method may further comprise associating each governance policy with a class of records.

The invention provides a system and method for applying lifecycle enforcement actions on information assets that are managed within multiple file plans within an entity, and physically located within multiple repositories in the jurisdictions where the sub-entities operate. This invention also imbues agility and updatability to this process, something that is seriously lacking in the current manual processes.

The invention can apply lifecycle controls and actions on information assets using a central policy management component, a federated governance lifecycle enforcement component, and the concept of repository agnosticism, which is the ability to apply governance controls on content (or information asset) in a universal way while it remains in-place and in the custody of another system. Content and “information asset” (used interchangeably in this document) are generic terms that refer to information that has been packaged for the purpose of use in business, for example, documents, invoices, customer statements, reports, etc.

The invention uses a system that may consist of three integrated modules, the Information Governance Policy Module (IGPM), the Information Governance Control Module (IGCM), and the Governance Policy Enforcement Layer (GPEL) connectors. These modules and connectors may be deployed together on the same computer system or decoupled and deployed on separate computer systems.

IGPM provides a central/corporate collaborative facility for the creation and management of a Master Classification and corresponding policies and rules governing information retention, security, data privacy, discovery, storage, and audit, while catering for jurisdictional differences in these policies. It may also provide for the configuration and deployment of these policies across the entity. These definitions may be stored in a database.

IGCM enables authorized operators in the sub-entities to access this database, create and manage file plans, associate these file plans with jurisdictions, and manage within these file plans the records in the sub-entity's custody.

The file plans include hierarchies of record classes and folders under these classes in which records and other forms of information are organized and their lifecycle is managed.

IGCM also allows these operators to manage the lifecycle of information and content in accordance with IG policies. It also enforces these policies across geographies and jurisdictions, platforms, and applications. This can be done by: (i) generating lists of eligible and approved actions (triggered by the passing of lifecycle milestones) and (ii) actioning and enforcing the lifecycle actions associated with these milestones. Through the integration with IGPM, the file plans in IGCM can include a subset or all of the Record Classes defined in IGPM. The governance policies assigned to the Record Classes in each file plan reflect the associated jurisdiction. IGCM may comprise of repository of information assets of its own.

GPEL may comprise one or multiple software connectors which are software modules that integrate IGCM with various repositories of information assets, and enforce the eligible and approved governance lifecycle actions on the information assets located in the repositories.

IGPM, IGCM and GPEL may maintain an audit trail of their operation and activities.

Other features of the invention can be found in the following description, the enclosed claims and/or the attached drawings.

### BRIEF DESCRIPTION OF THE DRAWINGS

For a fuller understanding of the nature and objects of the invention, reference should be made to the accompanying drawings and the subsequent description. Briefly, the drawings are:

FIG. 1 illustrates the inputs to a system or apparatus in keeping with the invention which is the combination of the IGPM and IGCM modules, and an output from that system or apparatus;

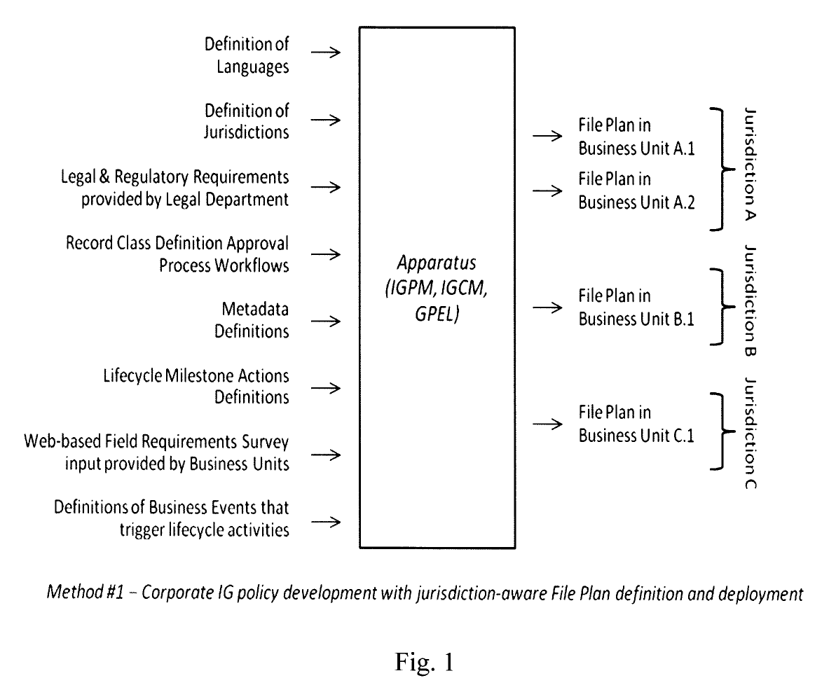

FIG. 2 illustrates the compound information governance policy definitions for record classes in keeping with the present invention;

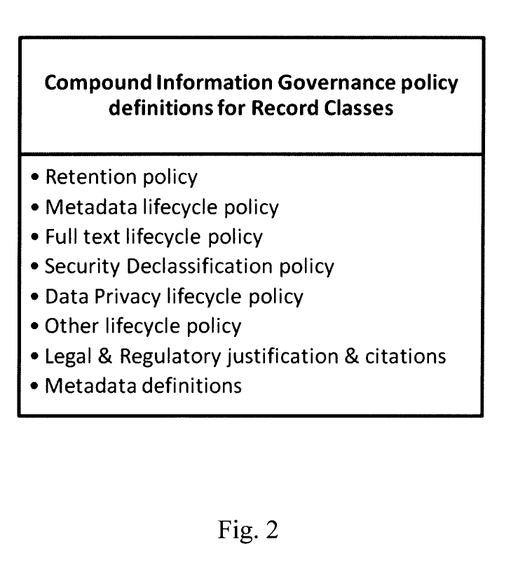

FIG. 3 illustrates the operation of the GPEL Connectors between IGCM and the integrated repositories in keeping with the invention. Specifically, it illustrates how the eligible governance lifecycle actions identified in IGCM are enforced on the information assets in the repositories; and,

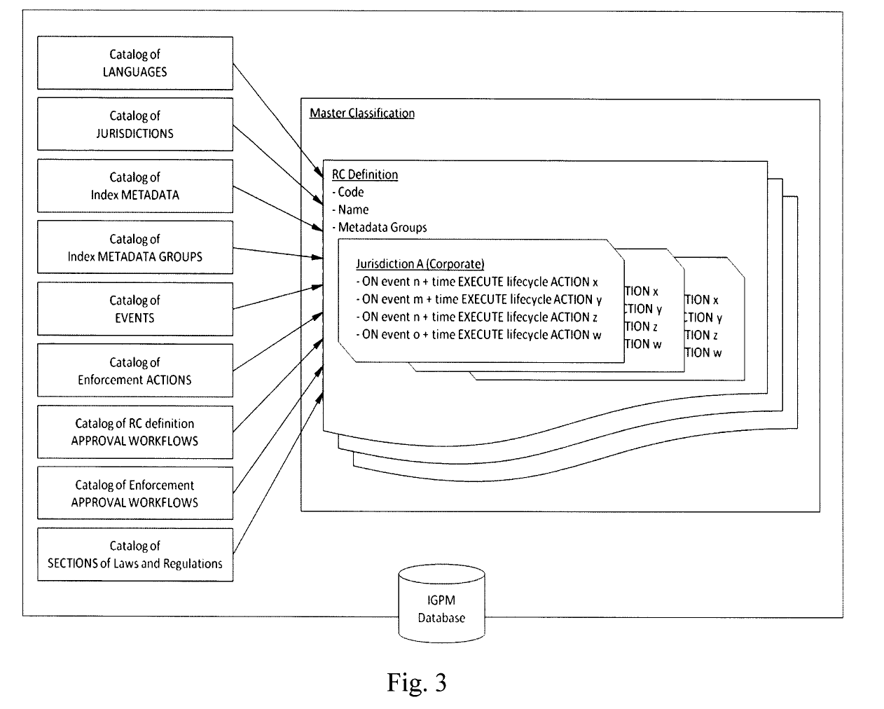

FIG. 4 illustrates the definition of the composite policies and rules in IGPM and their deployment in File Plans in the various jurisdictions in IGCM in keeping with the present invention.

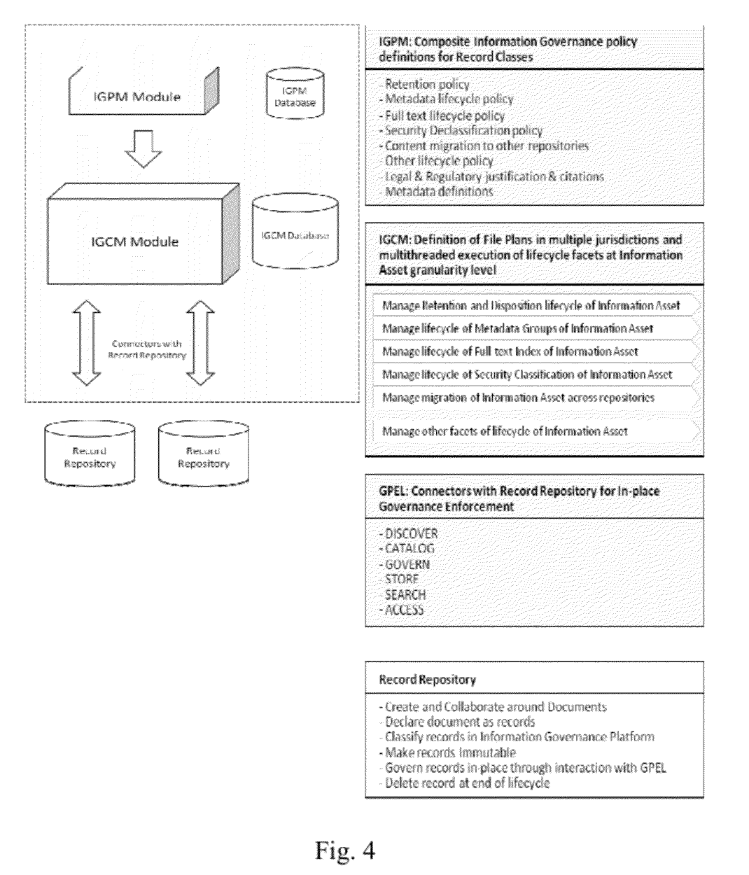

### FURTHER DESCRIPTION OF THE INVENTION

The present invention may be described with reference to (a) an input into an system, (b) a system, and (c) an output from that systems. It relates to the ability of the invention (and its modules) when used by authorized operators to utilize as input a set of eligible governance lifecycle actions on particular information assets that have been determined by File Plan-based lifecycle administration processes previously performed within IGCM. These processes themselves are based on the multi-jurisdictional policies and rules previously defined within IGPM. The output from the apparatus may be the resulting actual enforcement of these lifecycle actions on information assets while they remain in their repositories.

The invention brings together disparate lifecycle administration processes into a consistent and universal manner. For example, the invention may determine which information assets need to be destroyed one year after the occurrence of a particular business event such as the end of a contract, in all jurisdictions where the entity operates irrespective of where (which repository) the information assets are located and stored. After the eligible lifecycle actions are identified, the invention then enforces (executes) these actions on the information assets while they (the information assets) remain in their repositories.

Inputs. The input into the system, which comprises IGCM, and IGPM and the GPEL connectors, may include:
IGPM: Master Classification of RCs with multi-jurisdictional governance policies and rules
IGCM: File Plan-based lifecycle administration processes that generate lists of eligible lifecycle actions on information assets located within particular repositories

IGPM: Master Classification of RCs with governance policies and rules. The input into IGPM may include legal, regulatory and business requirements for the lifecycle of information assets as well as definitions of business events that impact the lifecycle of information assets, resulting in a Master Classification with Record Class definitions and policies and rules that reflect the governance lifecycle requirement of information assets in multiple jurisdictions. Such requirements and definitions may include:
Language definitions
Jurisdiction definitions
Legal and Regulatory Governance Requirements
Field requirement surveys representing business requirements
Business event definitions
Lifecycle approval workflows
Record Classes definitions
   Lifecycle rules, policies and actions for the Corporate jurisdiction
   Variations for lifecycle rules, policies and actions for other jurisdictions
   Metadata definitions

IGCM: File Plan-based lifecycle administration processes and eligible lifecycle actions on information assets located within repositories. The input into IGCM includes the RC definitions and the governance policies and rules defined for the jurisdictions. This input results in the definitions of multiple File Plans and the execution by authorized operators of lifecycle administration processes.

These processes in turn generate lists of eligible (ready to enforce) lifecycle actions on information assets located within particular repositories across the various jurisdictions where the entity operates. These lists of eligible and approved lifecycle actions are then input into the various GPEL connectors which enforce these actions on the information assets in the repositories.

The invention may be embodied as a method based on a computer system for generating approved lists of eligible governance lifecycle actions on information assets that are located with multiple repositories, and for enforcing these eligible lifecycle actions on the information assets while they remain in-place in the repositories.

One embodiment of a system in keeping with the invention comprises three integrated modules:

The first is an Information Governance Policy Module (IGPM) which may be used to create a Master Classification (MC) of Record Classes (RC) for the entity and corresponding governance rules for each of them. Multiple sets of rules may be created for each RC reflecting the governance requirements of each jurisdiction covered by the entity.

The second is an Information Governance Control Module (IGCM) which allows administrators in the sub-entities to create and manage file plans using the RC definitions created and managed in IGPM, associate these file plans with jurisdictions, and manage the sub-entity's records within them. It also allows these administrators to manage the lifecycle of these records in accordance with the policies defined in IGPM, and enforce these rules within geographies and jurisdictions, platforms and applications.

The third is a Governance Policy Enforcement Layer (GPEL) that may comprise one or multiple software connectors. These are software modules that tie (connect) IGCM to various repositories of information assets, and enforce the eligible and approved governance lifecycle actions on the information assets located in the repositories. From the IGCM perspective, this enforcement is applied in a uniform manner across all repositories. The software connectors in GPEL interpret the governance lifecycle enforcement actions into specific commands that can be executed by the individual integrated repositories and actually execute these commands in those repositories.

The apparatus may be operated by a number of users with different profiles and perspectives. The list of users may include, but is not limited to:

User #01—End-User in the sub-entity: The average user within a sub-entity who receives documents and records, creates them and exchanges them with internal and external parties.

User #02—Records Administrator in the sub-entity: The individual within the sub-entity, assigned the responsibility of carrying out the Information Governance Policies.

User #03—Corporate Records Manager: The individual within Corporate who may be responsible for the following activities:
Manage the process of creating the Information Governance Policies
Ensure that the policies are up to date
Ensure the policies are made available to the field Records Management personnel

User #04—Governance Steering Committee Member: The corporate officers responsible for overseeing and managing Information Governance program and for defining the policies and rules for governing information.

User #05—System Administrator: The individuals responsible for configuring and maintain the technical aspects of the governance platform (the invention) and the repositories that are integrated with it.

IGPM provides a centralized collaborative facility for the creation and management of policies governing information retention, security, data privacy, discovery, storage, and audit, while catering for jurisdictional differences in these policies. It also provides for the configuration and deployment of these policies across the entity.

The policies may be defined based on inputs such as:
Input based on legal and regulatory requirements in various jurisdictions including:
   Laws and regulations
   Constraints defined by laws and regulations
   Version control for laws and regulations
Input based on the requirements of business sub-entities covers operational information lifecycle needs. This may be performed using web-based field requirement surveys.

Authorized operators may use the input to create a Master Classification and associated File Plans.

The Master Classification is an organized hierarchy of unique Record Classes and representing the business functions of the entity and the unique types of records that are in use within these business functions. Each RC in this hierarchy comprises comprehensive structured definitions that may include:
RC numeric or alphanumeric code
RC name description
The RC definition approval workflow to follow
An indicator whether the RC is a “Default RC”, this means that this particular RC will appear automatically in every File Plan created in the sub-entities in IGCM
The sections of particular laws and regulations that require or recommend specific governance controls on records associated with such RC
The jurisdictions in which records associated with such RC are created and used
A master catalog of lifecycle triggering EVENTs, for example:
   End of mortgage for mortgage records
   End of employment for HR records
The governance policies and rules that may apply to the records associated with such RC, in each of these jurisdictions where these rules apply. The policies and rules are composite in nature and may include the following:
   Retention and disposition rules
   Data privacy rules
   Security declassification rules
   Migration across storage tiers
   Lifecycle of the full-text indexes belonging to specific information assets

An entity may have one Master Classification and multiple instances of the policies (one per jurisdiction). Once the Master Classification is created, local Records Managers in the field in various jurisdictions may request variations to the policies defined in the Master Classification.
Each RC definition may cover one or multiple jurisdictions where the entity operates.
Each jurisdiction may be associated with one or multiple languages.
Policies take the form of a Master Classification comprising unique and distinct definitions of Record Classes (and lifecycle policies) that reflect the major functions of the entity.
Record Class definitions incorporate metadata definitions for each Record Class
Master list of lifecycle triggering events.

The governance rules described above are expressed and persisted in IGPM in narrative form (human readable) as well as in the form of coded parameters that may be used directly by the lifecycle enforcement engine.

The rules defined for each of the lifecycle facets of the RCs in IGPM are based on the following formulas:
ON event+time, EXECUTE action
The event defined in the rule must be selected from the EVENT catalogue
The time period defined in the rule may be a numeric value and unit—the unit may be day, month, year
The action defined in the rule may be selected from the ACTIONS catalogue

IGCM enables authorized operators in the field to manage the lifecycle of information and content in accordance with the IG policies, and enforce these policies across geographies and jurisdictions, platforms and applications, repositories and data warehouses.
Create and manage File Plans in various Business Units within specific jurisdictions. Authorized users within the Business Units of the entity can create local File Plans.
   File Plans may include sub-sets of the Master Classification along with the appropriate policies that apply within the jurisdiction
   File Plans may be used to create folders within them and manage records within the folders.
Assign security to elements of File Plans. The security assignments (see list below) may be cumulative in effect, in other words, a user must meet all assigned security restrictions to be able to access the information item in the File Plan.
   Access Control List (ACL)
   Security Classification (not limited to):
      Top Secret
      Secret
      Confidential
      Restricted
      etc.
   Security Caveats (not limited to)—these additional restrictive designations:
      FOUO (For Official Use Only)
      NOFORN (Not Releasable to Foreign Nationals)
      etc.
Apply security on information assets managed within these File Plans.
Lifecycle of File Plan elements may be governed by jurisdiction-specific rules that have been propagated by IGPM and created in the File Plan.
Define mapping of metadata belonging to information in IGCM and corresponding information in integrated repositories. This mapping enables the definition of corresponding metadata elements between the RC definition in the File Plan and corresponding metadata in the supported repository.
   Example: in IGPM and IGCM an employee may be reference using a metadata attribute called EMP_NBR, however one of the repositories that has been integrated with IGCM may reference the employee using another metadata attribute such as EMPID.
The metadata mapping mechanism in IGCM enables IGCM to identify the corresponding content in the repositories and enforce the governance actions on them.
An external application may trigger the execution of an EVENT defined in IGPM and instantiated in one or multiple File Plans located in one or multiple instances of IGCM in the sub-entities.
   A business event may occur in an external application or process, example:
      “Employee_Retirement” for a particular employee referenced by his or her Employee ID
      “End_of_Contract” for a particular vendor contract referenced by the Contract Number
   The external application or process may notify one or multiple IGCM instances deployed within the sub-entities of the occurrence of such EVENT
   IGCM reacts to this EVENT notification by executing the corresponding EVENT for the relevant records (identified by the metadata); these are the records that meet the following criteria:
   The execution of the EVENT in IGCM may trigger one or multiple lifecycle activities, example:
      Start of record retention period
      Migration of records to different repository systems
      Start of record metadata retention period
Provide advanced functions for lifecycle planning:
   Identify information items that have eligible lifecycle actions in specified period of time
   Provide simulation capabilities, example show which records may be impacted from a lifecycle point of view (and how) if a particular event has occurred, example which records will be impacted and how if the end_of_contract event for a particular contact occurs.
Execute and manage approvals for eligible lifecycle actions as defined in IG policies propagated by IGPM. Some of the information items that have eligible lifecycle actions may require approvals prior to the enforcement of the actions on them. The IGCM provides a workflow functionality that supports these approval processes.
Maintain audit trail of the above activities.

GPEL consist of software connectors that integrate IGCM with one or multiple repositories of information assets. This allows IGCM to enforce the eligible and approved governance lifecycle actions on the information assets located in the repositories. From the IGCM perspective, this enforcement is applied in a uniform manner across all repositories in all jurisdictions. The software connectors in GPEL interpret the governance lifecycle enforcement actions into specific instructions understood by the individual integrated repositories and execute these commands in those repositories.
Each GPEL connector integrates a particular repository with IGCM
The GPEL connector communicates with IGCM using a protocol that is proprietary to the invention
The GPEL connector communicates with the repository using published and repository-specific APIs (Application Programming Interfaces):
   Discover
   Catalog
   Govern
   Store
   Search
   Access
The configuration of the GPEL Connector with a particular repository includes mapping functions:
   Mapping between RCs in IGPM/IGCM on one side and the corresponding Document Type definition in the repository, example:
      IGCM RC=Invoice<=>Repository Doc Type=Bill
   Mapping between metadata defined for RCs in IGPM/IGCM and metadata defined for their corresponding Doc Types in the Repository, example:
      IGCM Invoice Number<=>Repository Invoice ID
      IGCM Employee Number<=>Repository Employee #
   The mapping between RCs and their metadata (in IGPM/IGCM) and the corresponding Doc Types and metadata in the Repositories is required to provide context to GPEL and enable it to process and execute the enforcement functions on the information assets in the repository.

The in-place enforcement of the governance lifecycle is performed through an interaction between IGCM and the repositories via the GPEL connectors. The GPEL connectors support the following protocol of governance functions:
DISCOVER
   Based on rules defined in IGCM, identify items in the repository that need to be “GOVERNed”, and hence need to be “CATALOGed” and/or “STORE'd”
CATALOG
   Declare items in the application as records
   Create entries in a File Plan (in IGCM) that corresponds to these “items”
   Lock these items in the repository to prevent their editing and/or deletion.
GOVERN
   Apply governance controls to items in-place (retention, disposition, holds, event triggers, etc.)
STORE
   Function is used with applications that act as sources of information assets
   Migrate information asset to the archive of IGCM.
SEARCH
   Perform searches on governed information assets from the File Plans in IGCM.
ACCESS
   Access governed the information assets from the File Plans in IGCM.

The DISCOVER function determines in a discriminating manner, which information assets in a particular repository need to be “GOVERNed”:
This determination may be based on rules defined in IGCM (RC definitions)
Based on the role of the repository plays vis-à-vis IGCM, the action on the identified information assets may be as follows:
   “CATALOG” in IGCM if the repository can act as a system of records (a system that can provide immutability to information assets)
   “STORE” in IGCM and hence governed in the IGCM archive, if he repository lacks the ability to act as a system of records.

The CATALOG function allows the repository application to declare an information asset in the repository as a record and create a corresponding entry for that record in a particular File Plan in IGCM.
A user of the repository application or a process in that application may determine that an information asset (a document for example) is a record
The user or process selects a File Plan in IGCM, RC and Folder in IGCM in which to file the new record
The user or process provides values for the various record metadata (as defined in the RC definition in IGPM)
The GPEL connector acts in response to the above action and creates a “catalog” entry in the selected File Plan, RC and Folder that corresponds to “item”
The GPEL connector locks the item in the application repository by revoking the edit and delete rights to the item (information asset) in the repository are revoked
The GPEL connector may provide an indication within the repository application that the item in question has been declared as a record

The GOVERN function allows the governance processes provided by IGCM to be managed and enforced through the GPEL connectors. The governance processes in IGCM are themselves based on RC definitions and policies and rules defined for them in IGPM.
Lifecycle administration activities take place within IGPM in a repository agnostic way. This is done without impacting the information assets and the repositories that contain them:
   Determine which information assets need to be destroyed and when
   Determine which information assets need to have some of their metadata deleted for reasons of compliance with privacy requirements and when
   Determine which information assets must be placed on legal hold due to a litigation or an investigation
   Determine which information assets must have their legal hold lifted due to the end of a litigation or an investigation
   Determine which information must be migrated from an existing repository to another repository and when
Lifecycle actions that are determined to be eligible and approved within IGCM are transmitted to the individual integrated repositories through their respective GPEL connectors:
   Lift restrictions on edit actions
   Lift restrictions on delete actions
   Depending on the lifecycle action, either migrate information to another repository or delete it from current repository.

The execution of the lifecycle enforcement actions within the integrated repository may be:
Fully automatic
Assisted by the repository system administration via the exchange of lifecycle enforcement command sets generated by IGCM in the form of XML files and processed into the repository by the system administrator.

In summary, all lifecycle administration functions are performed in IGCM in a repository agnostic manner. In addition, the GPEL connectors perform the lifecycle enforcement actions on the information assets in their repositories (in-place).

The STORE function allows the repository application to declare an information asset in the repository as a record, create a corresponding entry for that record in a particular File Plan in IGCM, and move the particular information asset to the repository of IGCM.
A user of the repository application or a process in that application may determine that an information asset (a document for example) is a record
The user or process selects a File Plan in IGCM, RC and Folder in IGCM in which to file the new record
The user or process provides values for the various record metadata (as defined and required in the RC definition in IGPM)
The GPEL connector acts in response to the above action and creates a “catalog” entry in the selected File Plan, RC and Folder that corresponds to “item”
The GPEL connector moves the information asset from the repository to another repository as defined in the configuration of IGCM
If the STORE function of the GPEL connector is applied an information asset that has already been “CATALOG”ued, then the STORE function simply moves the item to the new repository and updates the status of that item in the IGCM database.

The SEARCH function allows the users and operators of IGCM to search for information assets whether these assets are still in their respective repositories (items simply “CATALOG”ued) or have been moved to another repository (items “MOVE”d).

The search in IGCM respects the security settings defined for the information assets in IGCM. These security settings may be based on security attributes assigned to the RCs in IGPM.
Search may be conducted on information assets from IGCM user interface
Search may be conducted on information assets already stored in the IGCM archive
Security on information assets respects security assigned to information assets in the IGCM archive and in other repositories

The ACCESS function allows the users and operators of IGCM to access and retrieve information assets from their respective repositories (items simply “CATALOG”ued) or from IGCM archive (items “MOVE”d).

The access in IGCM respects the security defined for the information asset in IGCM, which itself may be based on the security attributes assigned to the RCs in IGPM. Search may be conducted on information assets from the IGCM user interface

The output from the system is the execution of eligible and approved lifecycle enforcement actions on particular information assets within the repositories that are integrated with IGCM via the GPEL connectors, for example:
Lift restrictions on edit actions
Lift restrictions on delete actions
Depending on the lifecycle action, either . . .
   Migrate the information asset to another repository
   Delete the information asset from current repository

The execution of the lifecycle enforcement actions within the integrated repository may be:
Fully automatic
Assisted by the repository system administration via the exchange of lifecycle enforcement command sets generated by IGCM in the form of XML files and processed into the repository by the system administrator.

Embodiments of the present invention also include, without limitation, the following examples and combinations thereof:

### EXAMPLE 1

The invention consists of a method based on a computer system for creating for an entity one or multiple Master Classifications of types of records, referred to as Record Classes (RC), and multiple and associated File Plans that are based on that classification. The File Plans are used by the sub-entities of that entity to organize and govern (control the lifecycle of) their records. The records or information assets may be stored in repositories and their lifecycle is controlled and enforced in-place and in a universal manner via a number of governance enforcement connectors. The invention uses three integrated modules based on computer systems in order to achieve the above: The first is an Information Governance Policy Module (IGPM) which may be used to create a Master Classification (MC) of Record Classes (RC) for the entity and corresponding governance rules for each of them. Multiple sets of rules may be created for each RC reflecting the governance requirements of each jurisdiction covered by the entity. The second is an Information Governance Control Module (IGCM) which allows administrators in the sub-entities to create and manage file plans using the RC definitions created and managed in IGPM, associate these file plans with jurisdictions, and manage the sub-entity's records within them. It also allows these administrators to manage the lifecycle of these records in accordance with the policies defined in IGPM, and enforce these rules within geographies and jurisdictions, platforms and applications. IGCM may comprise of repository of information assets of its own. The third is a Governance Policy Enforcement Layer (GPEL) that may comprise one or multiple software connectors which are software modules that integrate IGCM with one or multiple repositories of information assets, and enforce the eligible and approved governance lifecycle actions on the information assets located within these repositories. From the IGCM perspective, this enforcement is applied in a uniform manner across all repositories. The software connectors in GPEL interpret the governance lifecycle enforcement actions into specific commands understood by the individual integrated repositories and execute these instructions in those repositories.

### EXAMPLE 2

The method of Example 1, wherein the Master Classification in IGPM is an organized hierarchy of unique Record Classes and representing the business functions of the entity and the unique types of records that are in use within these business functions. Each RC in this hierarchy comprises comprehensive structured definitions that may include the following:
RC numeric or alphanumeric code
RC name description
The sections of particular laws and regulations that require or recommend specific governance controls on records associated with such RC (details in Example 6)
The jurisdictions in which records associated with such RC are created and used (details in Example 5).
The governance rules that may apply to records associated with such RC, in each of these jurisdictions where these rules apply. These governance rules are agnostic are expressed in a generic way and in a manner that is agnostic to the type of repository that is connected with IGCM (via GPEL) and the type and format of information asset that is being governed.

### EXAMPLE 3

The method of Example 1, wherein the rules defined for each individual RC in IGPM may cover multiple lifecycle facets (composite) of information governance controls. This may include the following:
Rules for retaining and disposing of records associated with such RC
Rules for storing and migrating these records across repositories
Rules for retaining and disposing of specific metadata belonging to these records
Rules for retaining and disposing of the full-text indexes belonging to the record

The information governance rules described above are integrated together in each RC definition and for each jurisdiction in which they apply. As the above list indicates, some of these rules may affect the information assets themselves which are in the repositories and some may affect the metadata of the information assets which may be in the database of the IGCM module.

### EXAMPLE 4

The method of Example 1, wherein the governance policies and rules described above are expressed and are persisted in IGPM in narrative form (human readable) as well as in the form of coded parameters that may be used directly by the lifecycle enforcement engine and in a manner that is agnostic to the repositories that hold the information assets.

### EXAMPLE 5

The method in Example 1, wherein the jurisdictions in which the entity operates are defined in IGPM:
The jurisdictions in which the entity and its sub-entities operate are catalogued by name.
A jurisdiction may be a country, a state, a province, a canton, or any other types of legal domain, example US, NY State, and France.
The first jurisdiction defined is the Corporate jurisdiction, example USA for a US corporation and UK for a British corporation.
The corporate jurisdiction is the jurisdiction which rules apply everywhere within the entity except for RCs in specific jurisdictions where there are laws and regulations that require the application of different information governance rules.
Once jurisdictions are defined they become available for use within RC definitions.
Repositories may contain information assets located in multiple jurisdictions, thus the enforcement of the lifecycle actions on the information assets in these repositories will follow the policies and rules defined for the RCs in the jurisdictions

### EXAMPLE 6

The methods of Example 1 and Example 2, wherein IGPM may be populated with a catalogue of Laws and Regulations that may belong to one or multiple jurisdictions and may apply to information assets irrespective of the repository they are contained in:
The laws and regulations may be persisted in the database
The laws and regulations may be broken down section by section
Each law and regulation section may be referenced in the database with the following index metadata:
   Name of law or regulation
   Provenance of law or regulation
   Issuing date of law or regulation
   Issuing authority of law or regulation
   Jurisdiction in which the law or regulation applies (mapped to JURISDICTIONS catalogue)
   Section ID
   Section Title
   Section Text
   Lifecycle Constraints defined and required by that section
      EVENT that triggers the retention
      Minimum retention
      Maximum retention
      Enforcement ACTION
Content of laws and regulations may be imported into IGPM using an XML format
The enforcement of the lifecycle actions that result from the requirements of laws and regulations is universal across the repositories that are connected to the IGCM modules via the GPEL connectors.

### EXAMPLE 7

The methods in Example 1 and Example 3, wherein the rules defined for each of the lifecycle facets of the RCs in IGPM are based on the following formulas: ON event+time EXECUTE action:
The event defined in the rule must be selected from the EVENT catalogue (details in Example 9)
The time period defined in the rule may be a numeric value and unit—the unit may be day, month, year
The action defined in the rule may be selected from the ACTIONS catalogue (details in Example 10)

Rules based on the above formula may be defined for each lifecycle facet of each RC definition, including the following:
Retention and disposition of records
Storage and migration of records across repositories
Retention and disposition of specific record metadata
Rules for retaining and disposing of the record's full-text indexes

These rules are defined in manner that is agnostic to the repositories of information assets that are connected to the IGCM modules via the GPEL connectors.

### EXAMPLE 8

The methods in Example 1, Example 3 and Example 7, wherein multiple lifecycle rules may be defined for each facet of the definition of an RC in IGPM and this for each of the jurisdictions where this RC will apply, example for a retention and disposition rule of a record:
RC=Employee Records and Jurisdiction USA
   ON employee_retirement+7 years EXECUTE dispose of employee records APPLICABLE_ON record
   ON employee_termination+10 years EXECUTE dispose of employee records after HR Manager approval APPLICABLE_ON record
   ON employee_retirement EXECUTE migrate employee records to off-line storage (or off-site storage for physical records) APPLICABLE_ON record
RC=Employee Records and Jurisdiction France
   ON employee_retirement+20 years EXECUTE dispose of employee records after HR manager approval APPLICABLE_ON folder
   ON employee_retirement+5 years EXECUTE dispose of employee metadata protected by Privacy Laws APPLICABLE_ON folder

The APPLICABLE_ON element in the lifecycle formula determines if the lifecycle rule will apply to the individual record or to the folder that contains the record in the File Plan in IGCM. These rules are defined in a manner that is agnostic to the repositories of information assets that are connected with IGCM via the GPEL connectors.

### EXAMPLE 9

The methods in Example 1 and Example 8, wherein a standardized catalogue of EVENTS may be created and managed in IGPM, and thereof used within the definitions of the RC lifecycle rules also in IGPM. Each EVENT may include the following attributes:
Event Code (numeric or alphanumeric)
Event Name
Record Metadata associated with the Event (example Employee_ID for “employee_retirement”)

Each RC definition and jurisdiction variation thereof may be configured with a different mix of EVENTS. Refer to Example 13 for details about triggering event execution by external business applications.

The execution of EVENTs may impact information assets located in multiple repositories. This lifecycle impact will be enforced on the information assets in-place through the GPEL connectors to these repositories.

### EXAMPLE 10

The methods in Example 1 and Example 8, wherein a standardized catalogue of lifecycle enforcement ACTIONS may be created and managed in IGPM, and thereof used within the definitions of the RC lifecycle rules also in IGPM. Each enforcement ACTION may include the following index attributes:
Action Code (numeric or alphanumeric)
Action Name

Each RC definition and jurisdiction variation thereof may be configured with a different mix of ACTIONS. In addition, IGPM comes preconfigured with a number of enforcement actions, including:
Dispose of record
Dispose of record after pre-approval
Transfer of record
Delete metadata of record
Delete full text index of record

The lifecycle actions are enforced on the information assets within the repositories via the enforcement protocol supported in the GPEL connectors.

### EXAMPLE 11

The methods in Example 1, Example 8 and Example 10, wherein IGPM may allow the administrator to create one or multiple lifecycle ACTION approval workflows:
Each workflow may consist of one or multiple approval steps which may be sequenced in a mix of serial and parallel routes.
Each routing step may have a specific addressee
   Example Head of HR Department
Once an ACTION approval workflow is defined, it becomes accessible for use in RC definitions
Lifecycle actions are defined in IGPM in a repository agnostic manner, example “migrate information asset from repository 1 to repository 2”
The definitions of what repository 1 and repository 2 are in various deployments of IGCM
Once a lifecycle action is determined in IGCM to be eligible, it enforced on the information assets in the repositories that contain them. This enforcement is carried out through the interaction between IGCM and the repositories via the GPEL connectors.

### EXAMPLE 12

The method in Example 1, wherein the IGCM administrators in the sub-entities may create File Plans to manage the records in their custody:
Each File Plan may consist of a hierarchy of RCs, Folders and Records within them
Each File Plan may be associated with a specific sub-entity and a specific jurisdiction
The information assets managed within the File Plans may reside in multiple repositories and IGCM will perform the lifecycle management and enforcement functions across all these repositories.

### EXAMPLE 13

The methods in Example 1, Example 9 and Example 12, wherein an external application may trigger the execution of an EVENT defined in IGPM and instantiated in one or multiple File Plans located in one or multiple instances of IGCM in the sub-entities.
A business event may occur in an external application or process, example:
   “Employee_Retirement” for a particular employee referenced by his or her Employee ID
   “End_of_Contract” for a particular vendor contract referenced by the Contract Number
The external application or process may notify one or multiple IGCM instances deployed within the sub-entities of the occurrence of such EVENT
IGCM reacts to this EVENT notification by executing the corresponding EVENT for the relevant records (identified by the metadata); these are the records that meet the following criteria:
   Records' assigned RCs use this particular EVENT in their lifecycle definition
   Records that match the Record Metadata provided via the notification
The execution of the EVENT in IGCM may trigger one or multiple lifecycle activities, example:
   Start of record retention period
   Migration of records to different repository systems
   Start of record metadata retention period
The lifecycle activities that are triggered by an EVENT may be enforced on the information assets located within the repositories that are connected with IGCM via the GPEL connectors.

### EXAMPLE 14

The methods of Example 1, Example 2, and Example 10, wherein the repositories are connected to IGCM using the GPEL Connectors:
Each GPEL connector integrates a particular repository with IGCM
The GPEL connector communicates with IGCM using a protocol that is proprietary to the invention
The GPEL connector communicates with the repository using published and repository-specific APIs (Application Programming Interfaces)—details in Example 15:
   Discover
   Catalog
   Govern
   Store
   Search
   Access
The configuration of the GPEL Connector with a particular repository includes the following mapping functions:
   Mapping between RCs in IGPM/IGCM and their corresponding Document Type definitions in the repository, example:
      IGCM RC=Invoice<=>Repository Doc Type=Bill
   Mapping between metadata defined for an RC in IGPM/IGCM and metadata of the corresponding Doc Type in the Repository, example:
      IGCM Invoice Number<=>Repository Invoice ID
      IGCM Employee Number<=>Repository Employee #
   The mapping between the RCs and their metadata (in IGPM/IGCM) and the corresponding Doc Types and metadata in the Repositories is needed to provide context and to enable GPEL to execute the enforcement actions on the information assets in the repository.

### EXAMPLE 15

The methods of Example 1, Example 2 and Example 7, wherein the in-place enforcement of the governance lifecycle is performed through an interaction between IGCM and the repositories via the GPEL connectors. The GPEL connectors support the following protocol of governance functions:
DISCOVER
   Based on rules defined in IGCM, identify items in the repository that need to be “GOVERNed”, and hence need to be “CATALOGed” and/or “STORE'd”
CATALOG
   Declare items in the application as records
   Create entries in a File Plan (in IGCM) that corresponds to these “items”
   Lock these items in the repository to prevent their editing and/or deletion.
GOVERN
   Apply governance controls to items in-place (retention, disposition, holds, event triggers, etc.)
STORE
   Function is used with applications that act as sources of information assets
   Migrate information asset to the archive of IGCM.
SEARCH
   Perform searches on governed information assets from the File Plans in IGCM.
ACCESS
   Access governed the information assets from the File Plans in IGCM.

### EXAMPLE #16

The methods of Example 1, Example 2, Example 7 and Example 15, wherein the DISCOVER function determines in a discriminating manner, which information assets in a particular repository need to be “GOVERNed”:
This determination may be based on rules defined in IGCM (RC definitions)
Based on the role of the repository plays vis-à-vis IGCM, either a record source or record repository, the identified information assets may be simply “CATALOGed” in IGCM and hence governed in place, or “STORE'd” in IGCM hence governed in the IGCM archive.

### EXAMPLE #17

The methods of Example 1, Example 2, Example 7 and Example 15, wherein the CATALOG function, which is based on an API (Application Programming Interface) and is one of the core functions of the GPEL connectors, allows the repository application to declare an information asset in the repository as a record and create a corresponding entry for that record in a particular File Plan in IGCM.
A user of the repository application or a process in that application may determine that an information asset (a document for example) is a record
The user or process selects a File Plan in IGCM, RC and Folder in IGCM in which to file the new record
The user or process provides values for the various record metadata (as defined and required in the RC definition in IGPM)
The GPEL connector acts in response to the above action and creates a “catalog” entry in the selected File Plan, RC and Folder that corresponds to “item”
The GPEL connector locks the item in the application repository
   Edit rights to the item (information asset) in the repository are revoked
   Delete rights to the item (information asset) in the repository are revoked
The GPEL connector may provide an indication within the repository application that the item in question has been declared as a record

### EXAMPLE #18

The methods of Example 1, Example 2, Example 7 and Example 15, wherein the GOVERN function which is based on an API (Application Programming Interface) and is one of the core functions of the GPEL connectors, allows the governance processes provided by IGCM to be managed and enforced through the GPEL connectors. The governance processes in IGCM are themselves based on RC definitions and policies and rules defined for them in IGPM.
Lifecycle administration activities take place within IGPM (in a repository agnostic way) without impacting the information assets and repositories that contain them
   Determine which information assets need to be destroyed and when
   Determine which information assets need to have some of their metadata deleted for reasons of compliance with privacy requirements and when
   Determine which information assets must be placed on legal hold due to a litigation or an investigation
   Determine which information assets must have their legal hold lifted due to the end of a litigation or an investigation
   Determine which information must be migrated from an existing repository to another repository and when
Lifecycle actions that are determined to be eligible and approved within IGCM are transmitted to the individual integrated repositories through their respective GPEL connectors:
   Lift restrictions on edit actions
   Lift restrictions on delete actions
   Depending on the lifecycle action, either migrate information to another repository or delete it from current repository.

The execution of the lifecycle enforcement actions within the integrated repository may be:
Fully automatic
Assisted by the repository system administration via the exchange of lifecycle enforcement command sets generated by IGCM in the form of XML files and processed into the repository by the system administrator.

In summary, lifecycle administration functions are performed in IGCM in a repository agnostic manner. In addition, the GPEL connectors perform the lifecycle enforcement actions on the information assets in their repositories(in-place).

### EXAMPLE #19

The methods of Example 1, Example 2, Example 7 and Example 15, wherein the STORE function, which is based on an API (Application Programming Interface) and is one of the core functions of the GPEL connectors, allows the repository application to declare an information asset in the repository as a record, create a corresponding entry for that record in a particular File Plan in IGCM, and move the particular information asset to the repository of IGCM.
A user of the repository application or a process in that application may determine that an information asset (a document for example) is a record
The user or process selects a File Plan in IGCM, RC and Folder in IGCM in which to file the new record
The user or process provides values for the various record metadata (as defined and required in the RC definition in IGPM)
The GPEL connector acts in response to the above action and creates a “catalog” entry in the selected File Plan, RC and Folder that corresponds to “item”
The GPEL connector moves the information asset from the repository to another repository as defined in the configuration of IGCM
If the STORE function of the GPEL connector is applied an information asset that has already been “CATALOG”ued, as described in Example 16, then the STORE function simply moves the item to the new repository and updates the status of that item in the IGCM database.

### EXAMPLE #20

The methods of Example 1, Example 2, Example 7 and Example 15, wherein the SEARCH function, which is based on an API (Application Programming Interface) and is one of the core functions of the GPEL connectors, allows the users and operators of IGCM to search for information assets whether these assets are still in their respective repositories (items simply “CATALOG”ued) or have been moved to another repository (items “MOVE”d).

The search in IGCM respects the security settings defined for the information assets in IGCM. These security settings may be based on security attributes assigned to the RCs in IGPM. Search may be conducted on information assets from IGCM user interface.
Search may be conducted on information assets already stored in the IGCM archive
Security on information assets respects security assigned to information assets in the IGCM archive and in other repositories

### EXAMPLE #21

The methods of Example 1, Example 2, Example 7 and Example 15, wherein the ACCESS function, which is based on an API (Application Programming Interface) and is one of the core functions of the GPEL connectors, allows the users and operators of IGCM to access and retrieve information assets from their respective repositories (items simply “CATALOG”ued) or from IGCM archive (items “MOVE”d).

The access in IGCM respects the security defined for the information asset in IGCM, which itself may be based on the security attributes assigned to the RCs in IGPM. Search may be conducted on information assets from the IGCM user interface.

The following are a listing of terms and their related descriptions.

| Term | Description | Notes |
|---|---|---|
| BU | Business Unit within Entity | |
| CL | Corporate Language | |
| CTAM | Capture and Transparent Access | |
| | Module | |
| DoD 5015.2 | RMS standard by US Department of | |
| | Defense | |
| ECM | Enterprise Content Management | |
| ESI | Electronically Stored Information | US Federal Rules |
| | | of Civil |
| | | Procedure |
| FRCP | US Federal Rules of Civil Procedure | |
| GPEL | Governance Policy Enforcement Layer | |
| IG | Information Governance | |
| IGCM | Information Governance Control | Marketing Name: |
| | Module | RSD GLASS |
| | | Periscope |
| IGPM | Information Governance Policy Module | Marketing Name: |
| | | RSD GLASS |
| | | Mosaic |
| ISO | Reference model for open archival | OAIS |
| 14721:2003 | information system | |
| ISO 15489 | Best practices in RM | |
| JL | Jurisdiction Language | |
| MC | Master Classification | |
| MoReq2 & | Model Requirements for Electronic | European RM |
| 10 | Records Mgmt | standards |
| PII | Personally Identifiable Information | Data Privacy |
| RC | Record Class | |
| RC Group | Record Class Group | |
| RIM | Records and Information Management | Another common |
| | | term for RM |
| RM | Records Management | Subset of IG |
| RMA | RM Application | |
| RMS | US NARA specifications for RM | |
| | services | |
| RSD | RSD GLASS Governance Layer for | Trademark |
| GLASS ™ | Archival ServiceS | of RSD SA |
| TCS | Team Collaboration Site | Collaboration |
| | | tool such as |
| | | SharePoint |

Although the present invention has been described with respect to one or more particular embodiments, it will be understood that other embodiments of the present invention may be made without departing from the spirit and scope of the present invention. Hence, the present invention is deemed limited only by the appended claims and the reasonable interpretation thereof.

What is claimed is:

1. An integrated computer-based system for managing records, comprising:
one or more microprocessors programmed to execute instructions of a policy module, the policy module,
(a) configured to receive a plurality of management inputs, each management input describing a requirement arising from legal, business and/or information technology considerations, the requirement describing how a governance function must be carried out with respect to a record class, and
(b) using the management inputs to produce a governance policy for the record class;
one or more microprocessors programmed to execute instructions of a control module, the control module,
(a) configured to receive selection of one or more of the governance policies produced by the policy module, and
(b) configured to apply the selected governance policies to be applied to records created by a business division;
one or more microprocessors programmed to execute instructions of a connector module to apply governance actions, determined by the control module, on records within one or more record repositories;
a record repository which stores the records of the business division and which is responsive to the connector module's application of the selected governance policies and actions by storing, imposing immutability on, imposing mutability on, or deleting the records according to the selected governance policies; and
a communications network connected to the microprocessors and the record repository, the network facilitating,
(a) receipt of the management inputs, and
(b) selection and application of governance policies.

2. The system of claim 1, wherein the legal consideration arises from more than one jurisdiction.

3. The system of claim 1, wherein each governance policy includes a description of the management inputs.

4. The system of claim 1, wherein each governance policy identifies jurisdictions for which the governance policy is applicable.

5. The system of claim 1, wherein each governance policy is associated with a class of records.

6. The system of claim 1, wherein at least one of the governance policies identifies a business event that triggers application of the governance policy.

7. The system of claim 1, wherein at least one of the governance policies identifies a duration after which the governance policy is applied.

8. The system of claim 1, wherein at least one of the governance policies identifies at least one action that is triggered after the occurrence of an event and the passing of a time period.

9. The system of claim 1, wherein the governance policy includes more than one requirement and at least one of the requirements has an application date that is different from the other requirements.

10. The system of claim 1, wherein icons corresponding to records of a business unit appear in a file plan, the file plan being a graphical representation of a hierarchical organization of icons corresponding to record classes, folders, sub-folders, and records, wherein the icons corresponding to the record classes in the file plan represent one or more of the record classes defined in the policy module, and wherein each record class corresponds to a unique type of record, wherein each type of record identifies a particular business function, and wherein the icons corresponding to the folders and sub-folders represent organizing units of records with common features.

11. The system of claim 10, wherein each of the file plans is associated with a jurisdiction and associated with a set of governance policies representing the governance policies applicable in that jurisdiction.

12. The system of claim 1, wherein the connector module is responsive to a command from the control module to discover and identify records located within a repository.

13. The system of claim 1, wherein the connector module is responsive to a command from the record repository to catalog a record, already stored in the record repository, within a folder located within a file plan and associated with a record class, the catalog action,
(a) creating a record entry in the control module's file plan, in the selected folder representing the record
(b) creating metadata entries for that record in the control module file plan
(c) turning immutability on for that record in the record repository.

14. The system of claim 1, wherein the connector module is configured to respond to instructions from the control module to apply governance actions to the record located in the record repository, the governance actions, including at least one of:
(a) deleting a record,
(b) deleting metadata associated with a record,
(c) deleting full-text indexes belonging to a record,
(d) placing a litigation hold on the record,
(e) releasing the litigation hold from the record,
(f) moving a record from one record repository to another location, or
(g) reducing the security classification of a record to a lower security classification.

15. The system of claim 14, wherein the another location is another record repository.

16. The system of claim 14, wherein the governance rules and resulting actions when applied to a record are executed and enforced independently of each other.

17. The system of claim 1, wherein the connector module is responsive to instructions from the control module to store an electronic copy of the record located within the record repository into a record repository of the control module.

18. The system of claim 1, wherein the connector module is responsive to instructions from the control module to search for a record located within a record repository.

19. The system of claim 1, wherein the connector module is responsive to instructions from the control module to access, retrieve and display a record located within a record repository.

20. A method of managing records, comprising:
providing one or more microprocessors programmed to execute instructions of a policy module, the policy module,
(a) configured to receive a plurality of management inputs, each management input describing a requirement arising from legal, business and/or information technology considerations, the requirement describing how a governance function must be carried out with respect to a record class, and
(b) using the management inputs to produce a governance policy for the record class;
providing one or more microprocessors programmed to execute instructions of a control module, the control module,
(a) configured to receive selection of one or more of the governance policies produced by the policy module, and
(b) configured to apply the selected governance policies to be applied to records created by a business division;
providing one or more microprocessors programmed to execute instructions of a connector module to apply governance actions, determined by the control module, on records within one or more record repositories;
providing a record repository which stores the records of the business division and which is responsive to the connector module's application of the selected governance policies and actions by storing, imposing immutability on, imposing mutability on, or deleting the records according to the selected governance policies; and
providing a communications network connected to the microprocessors and the record repository, the network facilitating,
(a) receipt of the management inputs, and
(b) selection and application of governance policies;
receiving management inputs;
producing the governance policy;
receiving a selection of one or more of the governance policies;
using the connector module to apply the governance policies to the records;

21. The method of claim 20, wherein producing the governance policy includes adding a description of the management inputs.

22. The method of claim 20, wherein producing the governance policy includes identifying jurisdictions for which the governance policy is applicable.

23. The method of claim 20, further comprising associating each governance policy with a class of records.

24. The method of claim 20, wherein producing the governance policy includes identifies a business event that triggers application of the governance policy.

25. The method of claim 20, wherein at least one of the governance policies identifies a duration after which the governance policy is applied, and the step of applying the at least one governance policy occurs once the duration is achieved.

26. The method of claim 20, wherein at least one of the governance policies identifies at least one action that is triggered after the occurrence of an event and the passing of a time period, and the step of applying the at least one governance policy occurs once both the event occurs and the time has passed.

27. The method of claim 20, wherein the connector module is responsive to a command from the control module to discover and identify records located within a repository, and upon receiving the command, the connector module initiates actions to discover and identify records located within the repository.

28. The method of claim 20, wherein the connector module is responsive to a command from the record repository to catalog a record, already stored in the record repository, within a folder located within a file plan and associated with a record class; and
the response of the connector module to the command is to execute a catalog action, including:
(a) creating a record entry in the control module's file plan, in the selected folder representing the record;
(b) creating metadata entries for that record in the control module file plan; and
(c) turning immutability on for that record in the record repository.

29. The method of claim 20, wherein the connector module is configured to respond to instructions from the control module to apply governance actions to the record located in the record repository, and
receiving the instructions the connector module responds by applying at least one of the following governance actions:
(a) deleting a record,
(b) deleting metadata associated with a record,
(c) deleting full-text indexes belonging to a record,
(d) placing a litigation hold on the record,
(e) releasing the litigation hold from the record,
(f) moving a record from one record repository to another location, or
(g) reducing the security classification of a record to a lower security classification.

30. The method of claim 29, wherein the governance actions are applied independently of each other.

31. The method of claim 20, wherein the connector module is responsive to instructions from the control module to store an electronic copy of the record located within the record repository into a record repository of the control module; and the method includes receiving the instructions, and using the connector module to store the electronic copy of the record into the record repository of the control module.

32. The method of claim 20, wherein the connector module is responsive to instructions from the control module to search for a record located within a record repository, and the method includes receiving the instructions, and using the connector module to search for a record located within the record repository.

33. The method of claim 20, wherein the connector module is responsive to instructions from the control module to access, retrieve and display a record located within a record repository, and the method includes receiving the instructions and using the connector module to access, retrieve and display a record located within a record repository.
